(19) United States
(12) Patent Application Publication
(10) Pub. No.: US 2018/0174147 A1
(43) Pub. Date: Jun. 21, 2018

(54) SYSTEMS AND METHODS FOR BLOCKING INELIGIBLE FRAUD-RELATED CHARGEBACKS

(71) Applicant: MasterCard International Incorporated, Purchase, NY (US)

(72) Inventors: Kyle Williams, O'Fallon, MO (US); David J. Senci, Troy, IL (US); Michael James Rumford, Crystal Lake, IL (US)

(21) Appl. No.: 15/380,876

(22) Filed: Dec. 15, 2016

(51) Int. Cl. G06Q 20/40

(52) U.S. Cl. CPC G06Q 20/4016; G06Q 20/407

(57) ABSTRACT

A computer-implemented method for electronically linking accounts within a database and automatically blocking an ineligible fraud-related chargeback from chargeback processing over a network is provided. The method is implemented using a chargeback blocking computing device. The method includes linking an opened account with a closed account wherein the linked accounts are associated with a cardholder, storing a triggering rule configured to determine that a fraud-related chargeback is a triggering fraud-related chargeback, receiving a first chargeback, determining that the first chargeback is a first fraud-related chargeback associated with one of the linked accounts, determining that the first fraud-related chargeback is a triggering fraud-related chargeback based on the triggering rule, receiving a second fraud-related chargeback associated with one of the linked accounts, determining that the second fraud-related chargeback is an ineligible fraud-related chargeback by applying the triggering rule, and blocking the second fraud-related chargeback from further processing over the network.

### BACKGROUND

The field of the disclosure relates generally to electronically linking payment accounts within a database and, more particularly, to network-based systems and methods for linking related accounts within a database, and blocking ineligible fraud-related chargebacks associated with the linked accounts.

In today's world, payment transactions are often initiated with payment cards or some other type of payment on an account. At least some of these transactions end up being disputed by one of the parties involved in the transaction. These disputed transactions are at least sometimes resolved through a chargeback process. At least some known chargeback requests result from fraudulent transactions associated with a payment account. In at least some known instances, a cardholder requests chargebacks on allegedly fraudulent transactions that the cardholder knows are legitimate (also known as a “friendly fraud”). In some instances, the cardholder will lose the ability to submit future chargeback requests for that particular account, if friendly fraud is detected. However, in some cases, the cardholder knows that they are able to get around this restriction by obtaining a new payment card or cards that are associated with a different payment account. By doing so, the cardholder is then able to submit more friendly fraud chargebacks under these new accounts.

Additionally, in at least some known instances, an issuer bank may fail to promptly close an account that is used in one or more transactions potentially associated with friendly fraud. Rather, the issuer leaves the account open and continues to present the friendly fraud transactions to a merchant bank for chargebacks. The chargebacks are typically passed on from the merchant bank to merchants involved in the one or more transactions.

Transactions associated with friendly fraud present liability issues to the merchants, the issuers, and the acquirers involved in the transactions, and are responsible for a significant amount of financial losses. The processing of these transactions over the network is also a considerable burden on the bandwidth of the network. Accordingly, a system is needed that is configured to electronically link within a database multiple payment accounts so that chargebacks submitted by a single cardholder across multiple accounts can be detected and prevented.

### BRIEF DESCRIPTION

In one aspect, a computer-implemented method for electronically linking accounts within a database and automatically blocking an ineligible fraud-related chargeback from chargeback processing over a network is provided. The method is implemented using a chargeback blocking (CB) computing device that includes a processor and the database. The method includes linking by the CB computing device an opened account with at least one closed account wherein the linked accounts are associated with a cardholder, storing at least one triggering rule in the database configured to determine that a fraud-related chargeback is a triggering fraud-related chargeback wherein the at least one triggering rule includes at least one of a notification date rule and a counter value rule, receiving by the CB computing device a first chargeback submitted for chargeback processing, determining by the CB computing device that the first chargeback is a first fraud-related chargeback associated with one of the linked accounts, determining by the CB computing device that the first fraud-related chargeback is a triggering fraud-related chargeback based at least in part on the at least one stored triggering rule, receiving by the CB computing device a second fraud-related chargeback associated with one of the linked accounts after determining that the first fraud-related chargeback is the triggering fraud-related chargeback, determining that the second fraud-related chargeback is an ineligible fraud-related chargeback by applying the at least one triggering rule, and blocking the second fraud-related chargeback from further processing over the network.

In another aspect, a chargeback blocking (CB) computing device is provided. The CB computing device is configured to electronically link accounts within a database and automatically block an ineligible fraud-related chargeback from chargeback processing over a network. The CB computing device includes a processor, and a database coupled to the processor. The processor is configured to link an opened account with at least one closed account wherein the linked accounts are associated with a cardholder, store at least one triggering rule in the database wherein the at least one triggering rule is configured to determine that a fraud-related chargeback is a triggering fraud-related chargeback and wherein the at least one triggering rule includes at least one of a notification date rule and a counter value rule, receive from an issuer a first chargeback for an account associated with a cardholder wherein the chargeback includes an account identifier, determine that the first chargeback is a first fraud-related chargeback associated with one of the linked accounts, determine that the first fraud-related chargeback is a triggering fraud-related chargeback based at least in part on the at least one stored triggering rule, receive from the issuer a second fraud-related chargeback associated with one of the linked accounts after determining the first fraud-related chargeback is the triggering fraud-related chargeback, determine that the second fraud-related chargeback is an ineligible fraud-related chargeback by applying the at least one triggering rule, and block the second fraud-related chargeback from further processing over the network.

In another aspect, a computer-readable storage media having computer-executable instructions embodied thereon is provided. When executed by at least one processor associated with a chargeback blocking (CB) computing device, the computer-executable instructions cause the processor to link an opened account with at least one closed account wherein the linked accounts are associated with a cardholder, store at least one triggering rule in a database configured to determine that a fraud-related chargeback is a triggering fraud-related chargeback wherein the at least one triggering rule includes at least one of a notification date rule and a counter value rule, receive a first chargeback message for an account associated with the cardholder wherein the chargeback message includes an account identifier, determine that the first chargeback is a first fraud-related chargeback associated with one of the linked accounts, determine that the first fraud-related chargeback is a triggering fraud-related chargeback based at least in part on the at least one stored triggering rule, receive a second fraud-related chargeback associated with one of the linked accounts after determining that the first fraud-related chargeback is the triggering fraud-related chargeback, determine that the second fraud-related chargeback is an ineligible fraud-related chargeback by applying the at least one triggering rule, and block the second fraud-related chargeback from further processing over the network.

### BRIEF DESCRIPTION OF THE DRAWINGS

FIGS. 1-6 show example embodiments of the systems and methods described herein.

FIG. 1 is a schematic diagram illustrating an example multi-party payment card processing system for enabling payment transactions that includes a chargeback blocking (CB) computing device for linking accounts, and blocking ineligible fraud-related chargebacks associated with the linked accounts.

FIG. 2 is a flow diagram showing a dataflow of settling chargeback transactions with the CB computing device shown in FIG. 1.

FIG. 3 illustrates an example configuration of a server computing device such as the CB computing device shown in FIGS. 1 and 2.

FIG. 4 is a more detailed data flow block diagram of a payment card system that includes the CB computing device shown in FIGS. 1-3.

FIG. 5 is a process flow diagram of an example payment card system that includes the CB computing device as shown in FIGS. 1 and 2 for blocking ineligible fraud-related chargebacks associated with a linked account.

FIG. 6 is a block diagram of example fraudulent transactions that include a notification date and a counter value in accordance with one embodiment of the present disclosure.

### DETAILED DESCRIPTION

Disclosed herein is a chargeback blocking (CB) computing device, system, and method for linking accounts associated with a cardholder within a database, and blocking ineligible fraud-related chargebacks associated with the linked accounts based on at least one of a fraud notification date and a counter value. The CB computing device includes a memory (e.g., a database) and at least one processor in communication with the memory. The CB computing device is also in communication with a payment processing network. The CB computing device is configured to receive account data for cardholders from at least one issuer. The CB computing device is further configured to link closed accounts with newly opened accounts associated with a single cardholder to aggregate chargebacks across multiple accounts tied to the cardholder. In some embodiments, the CB computing device includes and/or is in communication with a linking component configured to receive and link the accounts. The CB computing device is also configured to receive fraud-related chargeback data, including at least an account identifier of a cardholder, from an issuer. The CB computing device is further configured to assign a notification date to the linked accounts in response to receiving a triggering fraud-related chargeback. The CB computing device is still further configured to block fraud-related chargebacks associated with payment transactions authorized by the issuer after the notification date. The CB computing device is also configured to block fraud-related chargebacks once a total number of fraud-related chargebacks associated with the linked accounts exceeds a predefined counter value.

In the example embodiment, the CB computing device, and more specifically the linking component, periodically receives account data for cardholders from one or more issuers, and maintains the account data in a database. More specifically, an issuer maintains one or more accounts for a cardholder, wherein each account is associated with an account identifier. If an account is closed, for example due to a fraudulent transaction associated with the account, the issuer may issue a new account (also known as a “reissued account”) with a new account identifier to the cardholder. The issuer transmits the closed account data and the new account data to the linking component. The linking component stores the closed account data and the new account data into the database. In some embodiments, the linking component is a separate device in communication with the CB computing device.

The linking component is configured to link together two or more accounts associated with a cardholder. More specifically, the linking component links closed accounts (e.g., expired accounts, accounts closed by an issuer or a cardholder, etc.) with new accounts (e.g., accounts issued by an issuer to replace closed accounts) associated with a cardholder. In some cases, a closed account for a cardholder may be issued by one issuer while a new account issued to the same cardholder is issued by a different issuer. The accounts may be linked based on a cardholder name, a personal identifier (e.g., a social security number), a previous account (e.g., an old account number), or some other identifier. For example, account A is issued to a cardholder, account A is closed and account B is issued to the cardholder; account B is closed and account C is issued to the cardholder; and account C is closed and account D is issued to the cardholder, accounts A, B, C, and D are stored in the database as linked accounts of the cardholder. Hereafter, closed accounts linked with new accounts associated with a cardholder are collectively referred to as a “linked account.”

In the example embodiment, an issuer submits chargebacks, including chargeback data, to a payment processing network (e.g., an interchange network or a clearinghouse network) after the cardholder requests a chargeback for a transaction associated with the cardholder's account. The CB computing device receives the chargebacks from the payment network (e.g., payment processor) and identifies fraud-related chargebacks based on a reason code included in the chargeback data. The reason code, which is typically assigned to the chargeback transaction by the issuer, may identify the chargeback as fraud-related. In these cases, the CB computing device is configured to identify the fraud-related reason codes and then analyze the chargeback further. The chargeback data further includes, but is not limited to, transaction data, such as, for example, an account identifier (either real or virtual), a transaction amount, a merchant identifier, an acquirer identifier, a transaction date-time, and an address verification.

The CB computing device stores the fraud-related chargeback data into the database. In particular, the database includes data fields for storing a total number of chargebacks submitted by an issuer associated with a linked account, a counter value associated with the linked account, and, if one was assigned, a notification date associated with the linked account. Upon receiving a fraud-related chargeback from the network, the CB computing device is configured to retrieve a linked account from the memory using an account identifier included in the chargeback data. In certain embodiments, the linked account is stored in the database based on account identifiers, and the chargeback data includes one or more account identifiers associated with the chargeback request. The CB computing device retrieves the linked account by searching each account included in the linked account for a matching account identifier.

In the example embodiment, the CB computing device assigns a notification date to the linked account. The CB computing device receives a triggering fraud-related chargeback, resulting in the CB computing device assigning a notification date to the linked account. The CB computing device assigns a notification date to the linked account by storing the notification date in the memory associated with the linked account. The triggering fraud-related chargeback occurs after the issuer has submitted a predefined number of fraud-related chargebacks on the linked account involving the same cardholder. For example, an issuer submits a first fraud-related chargeback on Account X assigned to a cardholder. Account X is closed and reissued to the cardholder as Account Y. Account X and Account Y are linked by the CB computing device (e.g., as a linked account). The issuer submits a second fraud-related chargeback on Account Y. In the example, the second fraud-related chargeback submitted by the issuer is the triggering fraud-related chargeback resulting in the CB computing device assigning a notification date to the linked account, the idea being that an issuer should know that the linked account has been compromised after two fraud-related transactions involving the same cardholder are submitted for chargeback. The notification date is the date and time that the triggering fraud-related chargeback is received by the CB computing device.

Once a notification date is associated with the linked account, for every other fraud-related chargeback involving the linked account, the CB computing device is configured to compare a transaction date included in the chargeback data with the notification date. In some cases, an issuer may continue to authorize transactions made on a closed account or a reissued account where the issuer should have known that the closed account or the reissued account was compromised. The CB computing device is configured to address this problem. If the transaction is authorized after the notification date, the CB computing device blocks the fraud-related chargeback from being submitted to the corresponding acquirer as part of the chargeback process. In the example embodiment, the CB computing device blocks the fraud-related chargeback by flagging the fraud-related chargeback as ineligible to be further processed by the payment processing network. Thus, these blocked fraud-related chargebacks are not processed further within the network, which reduces the impact of these chargebacks on the network infrastructure. For example, a notification date is assigned on January 5 to Account X associated with a cardholder. Account X is closed on January 10 and reissued the same day to the cardholder as Account Y. Account X and Account Y are linked by the CB computing device (e.g., the linked account). A fraudulent transaction is authorized by an issuer on Account Y on January 15. If the issuer submits the fraudulent transaction for a chargeback on January 20, the CB computing device blocks the chargeback as being ineligible because the transaction was authorized after the notification date. Conversely, the CB computing device does not block a fraudulent transaction that was authorized on January 4, but submitted for a chargeback on January 20, since the transaction was authorized before the notification date. The rules for when a chargeback is blocked by the CB computing device and not blocked are stored within the database.

In a further embodiment, the CB computing device is configured to count the number of fraud-related chargebacks submitted by an issuer on the linked account. More specifically, the CB computing device receives a triggering fraud-related chargeback when a number of submitted fraud-related chargebacks on the linked account equals a predefined counter value. The triggering fraud-related chargeback occurs once the counted number of fraud-related chargebacks submitted on the linked account equals the counter value, resulting in the CB computing device blocking any subsequent fraud-related chargebacks from being submitted on the linked account. For example, the counter value is 25, and the CB computing device determines that 30 chargebacks have been submitted by an issuer on Account X and Account Y associated with a cardholder (e.g., a linked account). The CB computing device determines that the 25^{th} chargeback is a trigger and the CB computing device blocks subsequent chargebacks from being transmitted to the acquirer. In this example, the CB computing device transmits 25 chargebacks to the acquirer for processing and blocks the other 5 chargebacks as being ineligible for exceeding the counter value. In some embodiments, the ineligible chargebacks are selected from a batch of chargebacks based on an order that the chargebacks are received by the CB computing device. In alternative embodiments, the ineligible chargebacks are selected based on the transaction authorization date and time. In the case where the CB computing device determines that a chargeback is to be blocked, the CB computing device blocks the chargeback message from being sent to the acquirer, and instead, sends a response message back to the issuer advising the issuer that the chargeback has been blocked for a particular reason (e.g., counter value exceeded). In some cases, a message may also be provided to the acquirer advising them of the blocked chargeback. By blocking the chargeback request, the CB computing device reduces fraud, and also improves the overall efficiency of the payment network by quickly identifying and eliminating these types of messages from further network processing.

The CB computing device is configured to use a predefined period of time when counting the number of fraud-related chargebacks submitted on linked account, for example, but not limited to, 120 days or 360 days. A fraud-related chargeback older than the predefined period of time is not counted towards the number of submitted fraud-related chargebacks on the linked account.

In one or more embodiments, the CB computing device appends the notification date to all fraud-related chargeback records occurring after the notification date for the linked account. For example, for any chargeback records transmitted to the acquirer after the notification date, the CB computing device appends the notification date to the chargeback message transmitted to the acquirer and/or the issuer.

In another embodiment, the CB computing device appends a number of chargebacks made on a linked account to all chargeback records associated with the linked account. For example, for any chargeback records received from the network (or the issuer) by the CB computing device, the CB computing device appends the number of chargebacks associated with the linked account to any chargeback messages transmitted to the acquirer and/or the issuer.

In another embodiment, upon blocking one or more ineligible fraud-related chargebacks, the CB computing device is further configured to generate and transmit a notification to the issuer and/or the acquirer that includes an explanation and/or a reason code for blocking the fraud-related chargeback. In the example embodiment, the notification is formatted based on the data included in the blocked fraud-related chargeback.

In still another embodiment, a requesting party (e.g., a merchant, an issuer, and/or an acquirer) can verify a number of chargebacks submitted on a linked account prior to, during, or after an authorization request by submitting a request to the CB computing device. For example, a requesting party may submit a request associated with a transaction initiated using an account that may be potentially compromised, during the transaction authorization process. The CB computing device receives the request from the requesting party. In response to receiving the request, the CB computing device looks up or otherwise retrieve linked account data from the database. In certain embodiments, linked account data is stored in the database based on account identifiers, and requests include an account identifier associated with the linked account for which the requesting party is requesting chargeback data. In response to the request, the CB computing device generates a response containing the number of chargebacks associated with the linked account. Once generated, the CB computing device transmits the response to the requesting party. In one embodiment, the request occurs in real time upon receipt of an authorization request message. This enables the requesting party and the CB computing device to take real time action, such as, for example, for the requesting party to approve or decline an authorization request.

In one embodiment, the linking component is an automatic billing updater (ABU) configured with data-chaining logic to link closed accounts and new accounts. The ABU provides merchants with up-to-date cardholder payment card information. To obtain updated billing data in such systems, a merchant generally submits an account query corresponding to one or more payment card accounts to the merchant's acquiring bank (also referred to herein as an “acquirer”) which then forwards the query to an ABU system. In response to the query, the ABU system retrieves corresponding billing data received from the issuer and transmits the retrieved billing data to the acquiring bank. The acquiring bank then forwards the retrieved billing data to the merchant, which may then update its database of account-on-file payment card information. During this process, the ABU receives and stores account data, including old (e.g., closed) accounts and new accounts associated with cardholders, in a database. The ABU uses data-chaining logic to link the old accounts and new accounts. The account data includes a primary account number (PAN), an expiry date, and/or other information associated with account-on-file transactions. The billing data received from the issuers may include updated account data, such as updated account data to replace an expired payment card.

In another embodiment, the CB computing device is configured to prevent an issuer from submitting chargebacks when a cumulative average chargeback value associated with a linked account exceeds a predefined threshold value. The cumulative average chargeback value is determined by dividing a total number of chargebacks associated with a linked account by a total number of accounts. For example, over time, a cardholder receives four payment cards, each payment card associated with a new account. The four accounts are linked to form a linked account. Card one has 10 chargebacks, card two has 2 chargebacks, card three has 6 chargebacks, and card four has 18 chargebacks. A total number of chargebacks associated with the linked account equals 36 chargebacks (i.e., 10+2+6+18=36). The total number of chargebacks is divided by a total number of accounts to determine a cumulative average chargeback value, which here is 9 chargebacks (i.e., 36/4=9). If the cumulative average chargeback value is greater than a predefined threshold value, for example, 10 chargebacks, the CB computing device blocks future chargebacks from the given issuer.

In the example embodiment, the CB computing device is configured to block one or more ineligible fraud-related chargebacks associated with a linked account. In alternative embodiments, these steps may be performed in a different order and/or one or more of the steps may be omitted. Specifically, a technical effect of the systems and processes described herein is achieved by performing at least one of the following steps by the CB computing device: (i) receive data associated with one or more closed accounts and/or one or more reissued accounts associated with a cardholder; (ii) electronically link within a database the one or more closed accounts with the one or more reissued accounts, resulting in a linked account; (iii) receive a plurality of chargebacks from one or more issuers, where each chargeback is associated with the linked account; (iv) identify, based on a chargeback reason code associated with each chargeback, fraud-related chargebacks from the plurality of chargebacks, wherein if a chargeback is not fraud-related, the chargeback is transmitted to a network for chargeback processing; (v) count, for the linked account, a number of fraud-related chargebacks submitted by an issuer, and determine when a triggering fraud-related chargeback occurs, the triggering fraud-related chargeback being a predefined number of fraud-related chargebacks submitted by the issuer on the linked account, resulting in the CB computing device assigning a notification date to the linked account; (vi) count, for the linked account, a number of fraud-related chargebacks submitted by an issuer to determine if the number of submitted fraud-related chargebacks exceeds a predefined counter value; (vii) for each fraud-related chargeback, determine whether a notification date is associated with the linked account or whether the number of submitted fraud-related chargebacks associated with the linked account exceeds the predefined counter value; (viii) if there is no notification date associated with the linked account and the number of submitted fraud-related chargebacks is less than or equal to the predefined counter value, the fraud-related chargeback is transmitted to the network for chargeback processing; (ix) if there is a notification date associated with the linked account, the CB computing device is configured to compare the transaction authorization date of the fraud-related chargeback to the notification date and block the fraud-related chargeback from being transmitted to the network for chargeback processing if the transaction was authorized after the notification date; (x) if the transaction was authorized before the notification date, the fraud-related chargeback is transmitted to the network for chargeback processing; and (xi) if the number of submitted fraud-related chargebacks exceeds the predefined counter value, the CB computing device is configured to block the fraud-related chargeback from being transmitted to the network for chargeback processing.

At least one of the technical problems addressed by the system described herein includes: (i) a high network load based, at least in part, on a high number of fraudulent transactions being transmitted to a payment processing network for chargeback processing, which results in network delays and reduced bandwidth; (ii) high network load, based at least in part, on otherwise ineligible or avoidable chargebacks being transmitted to an acquirer, which results in network delays and reduced bandwidth; (iii) failure to close accounts after one or more fraudulent purchases; (iv) allowing fraudulent transactions to be processed on the payment processing network as authorized transactions; (v) allowing ineligible fraudulent transactions to be processed as chargebacks; (vi) consumer inconvenience based at least in part on having to request chargebacks on fraudulent transactions; (vii) canceling accounts issued to consumers due to continued fraudulent transactions, thus leading to lost sales for merchants and lost processing fees for the other network parties based on those lost transactions; (vii) increased risk with merchant liability for fraudulent transactions; and (viii) decreasing friendly fraud where a cardholder receives a new or reissued account to continue requesting chargebacks.

The technical effect achieved by this system is at least one of: (i) reducing an amount of network and computing resources needed to process fraudulent transactions; (ii) reducing a number of fraudulent transactions being processed; (iii) reducing an amount of network and computing resources needed to process chargebacks; (iv) reducing a number of chargebacks being processed; (v) reducing consumer inconvenience; (vi) reducing a number of transactions that are lost due to consumers canceling their payments cards due to fraudulent transactions, and thus reducing lost sales for merchants and reducing lost fees for other network parties based on those lost transactions; and (vii) enabling liability shift to issuers for some transactions, such that issuers are incentivized to close accounts with fraudulent transactions or relinquish their fraud-related chargeback rights for any further fraudulent transactions associated with a linked account. For example, network resources and computing resources are reduced by reducing the number of fraudulent transactions. Network resources and computing resources are further reduced by reducing the number of chargebacks, and thus reducing the number of chargebacks transmitted and processed across the network. Instead of allowing every fraudulent transaction to be submitted by the issuer as a chargeback, the present system intelligently blocks the submission of certain fraud-related chargebacks after a criterion is met. One or more of the parties to the transaction are benefitted by the system by, for example, less burden on the consumer to report fraudulent transactions and request chargebacks, less lost sales and less processing of chargebacks for the merchant and the acquirer, and less lost sales and less processing of chargebacks for the issuer.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, digital wallets, and/or computers. Each type of transactions card can be used as a method of payment for performing a transaction. As used herein, the term “payment account” is used generally to refer to the underlying account with the transaction card. In addition, cardholder card account behavior can include but is not limited to purchases, management activities (e.g., balance checking), bill payments, achievement of targets (meeting account balance goals, paying bills on time), and/or product registrations (e.g., mobile application downloads).

The following detailed description illustrates embodiments of the disclosure by way of example and not by way of limitation. It is contemplated that the disclosure has general application to blocking chargebacks in industrial, commercial, and residential applications, and not limited to fraud-related chargebacks. For example, in some embodiments, the CB computing device blocks chargebacks submitted by an issuer where an account identifier is not listed in a warning bulletin at the time of a transaction. In some alternative embodiments, the CB computing device blocks chargebacks where an issuer claims the transaction was not authorized but it is shown by a clearing record that the transaction was authorized by an embedded chip in a credit or debit card.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

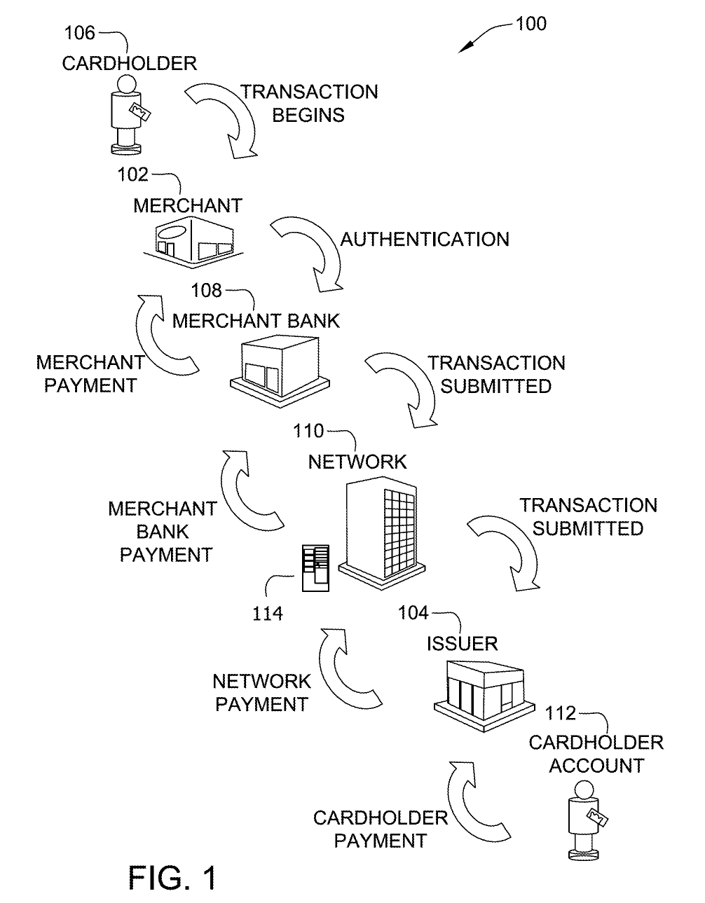

FIG. 1 is a schematic diagram illustrating an example multi-party payment card processing system 100 for enabling payment-by-card transactions including a chargeback blocking (CB) computing device 114 for identifying and linking associated accounts within a database, and blocking ineligible fraud-related chargebacks associated with the linked accounts. The present disclosure relates to payment card system 100, such as a credit card payment system using the MasterCard® payment card system payment network 110 (also referred to as an “interchange” or “interchange network”). MasterCard® payment card system payment network 110 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or a cardholder 106, who uses the transaction card to tender payment for a purchase from a merchant 102. To accept payment with the transaction card, merchant 102 must normally establish an account with a financial institution that is part of the financial payment system. This financial institution is usually called the “merchant bank,” the “acquiring bank,” or the “acquirer.” When cardholder 106 tenders payment for a purchase with a transaction card, merchant 102 requests authorization from an acquirer 108 for the amount of the purchase. The request may be performed over the telephone, but is usually performed through the use of a point-of-sale terminal, which reads cardholder's 106 account information from a magnetic stripe, a chip, or embossed characters on the transaction card and communicates electronically with the transaction processing computers of acquirer 108. Alternatively, acquirer 108 (also referred to as merchant bank) may authorize a third party to perform transaction processing on its behalf. In this case, the point-of-sale terminal is configured to communicate with the third party. Such a third party is usually called a “merchant processor,” an “acquiring processor,” or a “third party processor.”

Using an interchange network 110, computers of acquirer 108 or merchant processor communicates with computers of an issuer 104 to determine whether cardholder's account 112 is in good standing and whether the purchase is covered by cardholder's 106 available credit line. Based on these determinations, the request for authorization is declined or accepted. If the request is accepted, an authorization code is issued to merchant 102.

When a request for authorization is accepted, the available credit line of cardholder's account 112 is decreased. Normally, a charge for a payment card transaction is not posted immediately to cardholder's account 112 because bankcard associations, such as MasterCard International Incorporated®, have promulgated rules that do not allow merchant 102 to charge, or “capture,” a transaction until goods are shipped or services are delivered. However, with respect to at least some debit card transactions, a charge may be posted at the time of the transaction. When merchant 102 ships or delivers the goods or services, merchant 102 captures the transaction by, for example, appropriate data entry procedures on the point-of-sale terminal. This may include bundling of approved transactions daily for standard retail purchases. If cardholder 106 cancels a transaction before it is captured, a “void” is generated. If cardholder 106 returns goods after the transaction has been captured, a “credit” is generated. Interchange network 110 and/or issuer 104 stores the transaction card information, such as a type of merchant, amount of purchase, date of purchase, in a data warehouse (not shown).

After a purchase has been made, a clearing process occurs to transfer additional transaction data related to the purchase among the parties to the transaction, such as acquirer 108, interchange network 110, and issuer 104. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction.

As used herein, the term “transaction data” refers to data that includes at least a portion of a cardholder's account information (e.g., cardholder name, account identifier, credit line, security code, and/or expiration data) and at least a portion of purchase information (e.g., price, a type of item and/or service, SKU number, item/service description, purchase date, and/or confirmation number) supplied by a merchant from which the cardholder is making a purchase.

After a transaction is authorized and cleared, the transaction is settled among merchant 102, acquirer 108, and issuer 104. Settlement refers to the transfer of financial data or funds among cardholder's account 112, acquirer 108, and issuer 104 related to the transaction. Usually, transactions are captured and accumulated into a “batch,” which is settled as a group.

In some transactions, cardholder 106 may request a refund or initiate a chargeback of funds. In addition, a chargeback may occur for technical reasons such as insufficient funds, clerical reasons such as duplicate billing and/or incorrect amount billed, quality reasons such as when a consumer claims to have never received the goods as promised, and/or fraud reasons where a consumer did not authorize the purchase.

To initiate a chargeback, cardholder 106 contacts issuer 104 and disputes a transaction. Issuer 104 submits the chargeback for the transaction to interchange network (e.g., payment processor) 110, which provides clearing and settlement services to its registered parties. Interchange network 110 submits the chargeback to acquirer 108. Acquirer 108 either resolves the dispute or forwards it to merchant 102. Merchant 102 either accepts the chargeback or re-presents it back to acquirer 108. Acquirer 108 forwards the response from merchant 102 back to interchange network 110. Interchange network 110 then settles the chargeback with issuer 104. Based on the response, issuer 104 either reposts the charge to cardholder account 112 or resubmits the transaction to interchange network 110 for a financial liability decision. Issuer 104 also provides cardholder 106 a dispute resolution summary. In some embodiments, the third party issuer processor performs chargeback processing on behalf of issuer 104. In these embodiments, issuer 104 submits chargeback messages that include reason codes to the issuer processor, and the issuer processor communicates with interchange network 110 to settle the chargeback. Issuer 104 may choose to receive the settlement funds directly from interchange network 110 after settlement occurs, or alternatively, issuer 104 may authorize the issuer processor to settle with interchange network 110, and then issuer 104 settles with the issuer processor.

CB computing device 114 is in communication with network 110 (e.g., payment processor) and is configured to receive chargeback data from network 110. In some embodiments, CB computing device 114 is further in communication with issuer 104 and is configured to receive account data for cardholders from issuer 104. In alternative embodiments, CB computing device 114 receives account data for cardholders from network 110. As further explained below, CB computing device 114 is configured to block a fraud-related chargeback transaction between issuer 104 and acquirer 108 where (1) a payment transaction resulting in the fraud-related chargeback occurred after a notification date was associated with a linked account, or (2) a total number of submitted fraud-related chargebacks associated with the linked account exceeds a counter value.

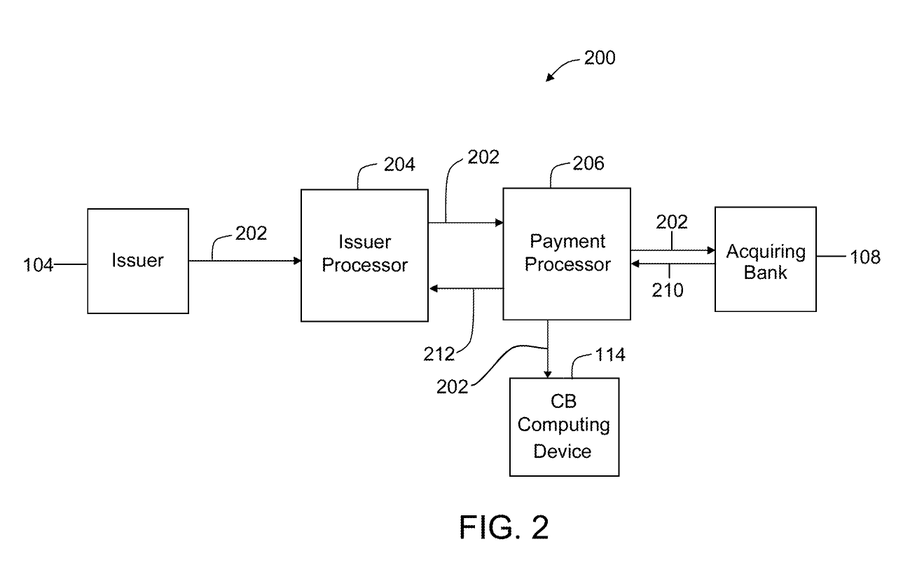

FIG. 2 is a data flow block diagram of a payment card system 200 used to settle chargeback transactions that includes chargeback blocking (CB) computing device 114 (shown in FIG. 1). In the example embodiment, CB computing device 114 is configured to block a fraud-related chargeback transaction between issuer 104 and acquirer 108 where (1) a payment transaction resulting in the fraud-related chargeback occurred after a notification date was associated with a linked account, or (2) a total number of submitted fraud-related chargebacks associated with the linked account exceeds a counter value. CB computing device 114 is further configured to transmit a notification to issuer 104 and/or acquirer 108 that includes a reason that the fraud-related chargeback was blocked. The chargeback relates to a dispute lodged by a cardholder with respect to at least one transaction assigned to an account associated with a linked account.

As part of the chargeback process, at least one issuer 104 transmits a chargeback request received from a cardholder (not shown) as a chargeback transaction 202 to an issuer processor 204 for chargeback settlement. Chargeback transaction 202 includes transaction data relating to the original transaction. Issuer processor 204 generates a batch file of chargeback transactions 202, which include multiple chargeback transactions 202 from multiple issuers 104, to transmit to a payment processor 206 for chargeback settlement. Payment processor 206 includes or is in communication with CB computing device 114. Payment processor 206 processes chargeback transactions 202 and transmits eligible chargeback transactions 202 to acquirers 108 determined from the transaction data included within chargeback transactions 202 for settlement. In the example embodiment, payment processor 206 communicates chargeback transactions 202 to CB computing device 114 before sending to acquirer 108. In further embodiments, CB computing device 114 is part of payment processor 206. In some embodiments, CB computing device 114 receives the chargeback transactions 202 and flags any ineligible chargeback transactions. The flagged ineligible chargeback transactions are blocked from being sent by payment processor 206 to acquirers 108. Payment processor 206 then transmits eligible chargeback transactions 202 to acquirers 108. Payment processor 206 may be associated with payment card system interchange network 110.

In operation, issuer 104 transmits chargeback transaction 202, including transaction data relating to the original transaction for which chargeback is requested, to issuer processor 204 for chargeback settlement. Issuer processor 204 creates a record for chargeback transaction 202 and stores it in the batch file. The detailed record includes transaction data, cardholder account identifier, and an issuer ID associated with issuer 104 that is assigned by issuer processor 204. Issuer processor 204 repeats this process for multiple chargeback transactions 202 received from multiple issuers 104. At the end of each day, issuer processor 204 transmits chargeback transactions 202, which includes multiple detailed records, to payment processor 206 for chargeback settlement.

As explained further below, CB computing device 114 receives chargeback transactions 202 from payment processor 206 to determine whether one or more fraud-related chargeback transactions 202 are ineligible for chargeback and should be blocked from being transmitted to acquirer 108. In some embodiments, payment processor 206 transmits data 212 back to issuer processor 204, which may include a chargeback response message 210 from acquirer 108.

Payment processor 206 processes chargeback transactions 202 and transmits each chargeback transaction 202 to an associated acquirer 108 based on the transaction data. In the example embodiment, payment processor 206 facilitates the clearing, settlement, and chargeback processing of transactions between acquirers 108 and issuers 104 (or issuer processors on behalf of issuers 104).

In one embodiment, acquirers 108 may not respond to a chargeback request. In alternative embodiments, acquirers 108 may transmit a chargeback response message 210 representing acknowledgement from acquirers 108 to payment processor 206. Inasmuch as chargeback transactions are known as “force post” transactions, chargeback transactions are settled whether or not acquirers 108 agree with chargeback transactions 202.

Although only one issuer 104, one issuer processor 204, one payment processor 206, and one acquiring bank 108 are illustrated, it should be understood that system 200 may include any number of issuers 104, issuer processors 204, payment processors 206, and/or acquiring banks 108 in communication with CB computing device 114.

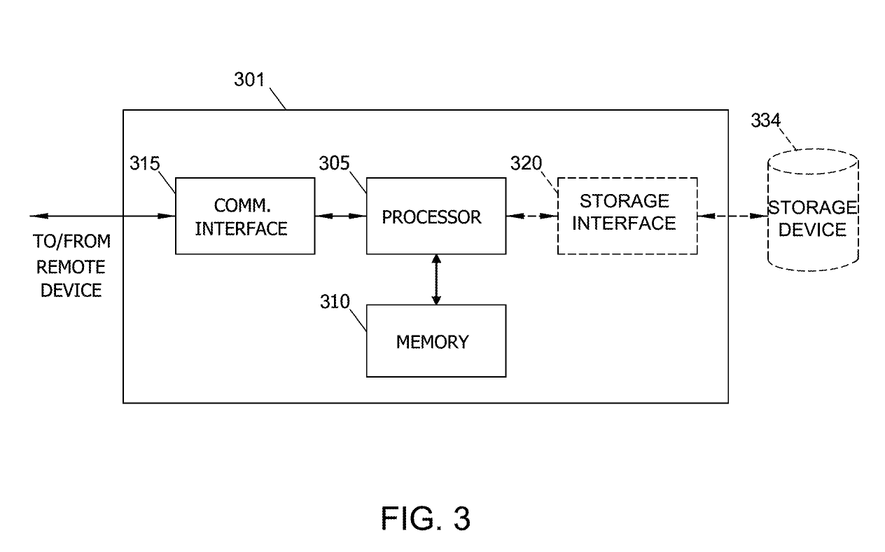

FIG. 3 illustrates an example configuration of a computing device 301 such as CB computing device 114 and/or payment processor computing device 206 (shown in FIG. 2) and/or issuer processor computing device 204 (shown in FIG. 2). Device 301 includes a processor 305 for executing instructions. Instructions may be stored in a memory area 310, for example. Processor 305 may include one or more processing units (e.g., in a multi-core configuration) for executing instructions. The instructions may be executed within various different operating systems on the device 301, such as UNIX®, LINUX® (LINUX is a registered trademark of Linus Torvalds), Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that computing device 301 is capable of communicating with a remote device such as a user system or another computing device 301. For example, communication interface 315 may receive requests via the Internet.

Processor 305 may also be operatively coupled to a storage device 334. Storage device 334 is any computer-operated hardware suitable for storing and/or retrieving data. In some embodiments, storage device 334 is integrated in system 301. For example, computing device 301 may include one or more hard disk drives as storage device 334. In other embodiments, storage device 334 is external to computing device 301 and may be accessed by a plurality of computing devices 301. For example, storage device 334 may include multiple storage units such as hard disks or solid state disks in a redundant array of inexpensive disks (RAID) configuration. Storage device 334 may include a storage area network (SAN) and/or a network attached storage (NAS) system.

In some embodiments, processor 305 is operatively coupled to storage device 334 via a storage interface 320. Storage interface 320 is any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

Memory area 310 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

In one embodiment, storage device 334 may store account data including at least one of a cardholder name, an account identifier (i.e., an account number), a personal identification number, an address, a telephone number, bank data, a notification date, and a counter value associated with a linked account. The account data may further include new accounts an expired accounts or changed accounts where the accounts numbers were replaced by new account numbers or closed. Storage device 334 may also store merchant data including a merchant identifier that identifies each merchant registered to use the payment account card network, and instructions for settling transactions including acquirer account information. Storage device 334 may also store purchase data associated with items being purchased by a cardholder from a merchant, and authorization request data.

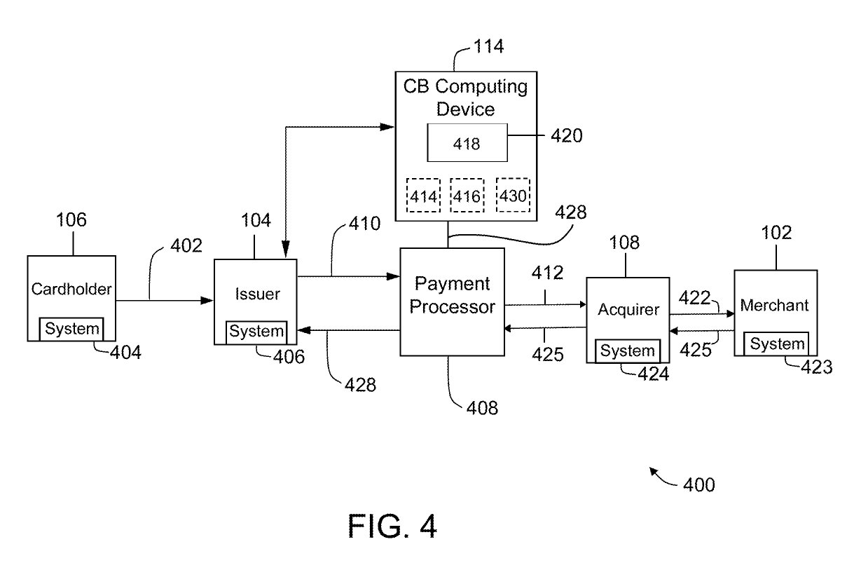

FIG. 4 is a more detailed schematic data flow diagram of an example payment card system 400 that includes CB computing device 114 (shown in FIGS. 1 and 2) for blocking ineligible chargeback transactions between at least one issuer and at least one acquirer. Payment card system 400 is similar to system 200 shown in FIG. 2. In the example embodiment, the data flow within system 400 includes transmitting a chargeback request 402 by a cardholder, for example, cardholder 106 (shown in FIG. 1). More specifically, cardholder 106 makes a chargeback request 402 to an issuer, for example, issuer 104 (shown in FIG. 1). Where reference is made to cardholder 106 herein, such reference may include reference to a computing system or computing device 404 operated by or associated with cardholder 106 (e.g., a mobile computing device such as a smart phone or any other computing device). Similarly, where reference is made to issuer 104, acquirer 108, and merchant 102 (both also shown in FIG. 1), respectively, such reference may include reference to a computing system 406 associated with issuer 104 (an “issuer computing system 406”), a computing system 424 associated with acquirer 108 (an “acquirer computing system 424”), and a computing system 423 associated with merchant 102 (a “merchant computing system 423”), respectively.

In the example embodiment, chargeback request 402 relates to a request for a chargeback of at least a portion of an original transaction. Chargeback request 402 relates to the original transaction with a merchant, for example, merchant 102, that is charged to an account assigned to cardholder 106, where cardholder 106 requests that a chargeback be applied. The original transaction would have been initiated using the payment card issued to cardholder 106 by issuer 104 and would have been processed by a payment processor 408, which is similar to payment processor 206.

Issuer 104 receives chargeback request 402 from cardholder 106 at issuer computing system 406. In the example embodiment, issuer 104 transmits chargeback request 402 as a chargeback transaction 410 to CB computing device 114. Chargeback transaction 410 represents chargeback request 402 submitted by cardholder 106. Chargeback transaction 410 is transmitted from issuer computing system 406 to payment processor 408 and CB computing device 114. Alternatively, chargeback transaction 410 is transmitted directly from issuer computing system 406 to CB computing device 114. In the example embodiment, chargeback transaction 410 includes transaction data relating to the original transaction.

In the example embodiment, CB computing device 114 identifies and blocks ineligible chargeback transactions. Payment processor 408 transmits eligible chargeback transaction files to acquirer 108 for chargeback settlement. In the example embodiment, CB computing device 114 includes a processor 414, a memory device 416, and a storage device 420 for storing data 418. In an alternative embodiment, CB computing device 114 may be associated with payment processor 408. Storage device 420 is any computer-operated hardware suitable for storing and/or retrieving data. For example, storage device 420 may include multiple storage units such as hard disks or solid state disks in a redundant array of inexpensive disks (RAID) configuration. Storage device 420 includes data 418 relating to fraud-related chargebacks, including, but not limited to, account data, account identifiers, notification dates, counter values, and rules for processing the fraud-related chargebacks.

When payment processor 408 receives a chargeback transaction 410, payment processor 408 generates a chargeback transaction file 412, which includes detailed transaction records for chargeback transaction 410. In the example embodiment, payment processor 408 transmits eligible chargeback transaction file 412 to acquirer computing system 424 of acquirer 108. Merchant 102 receives a chargeback request 422 at a merchant computing system 423. While in one example embodiment, merchant 102 does not respond to chargeback request 422, in another embodiment, merchant 102 may transmits a chargeback response message 425 acknowledging receipt of chargeback request 422, which is subsequently forwarded by acquirer 108 to payment processor 408.

In some embodiments, payment processor 408 transmits data 428 to CB computing device 114, which can be then transmitted to issuers 104. In alternative embodiments, payment processor 408 transmits data 428 directly to issuers 104. Data 428 may include chargeback responses, message type code segment, settlement position detail records, and unique file identifiers. Position detail records include updated transaction information. A unique file identifier is the same identifier for each chargeback transaction file when transmitting batch files and is associated with a specific chargeback transaction 410.

In the example embodiment, CB computing device 114 includes a linking component 430. Linking component 430 receives account data for cardholders from one or more issuers and links together accounts associated with a cardholder, as described herein. In some embodiments, linking component 430 is a separate computing device in communication with CB computing device 114.

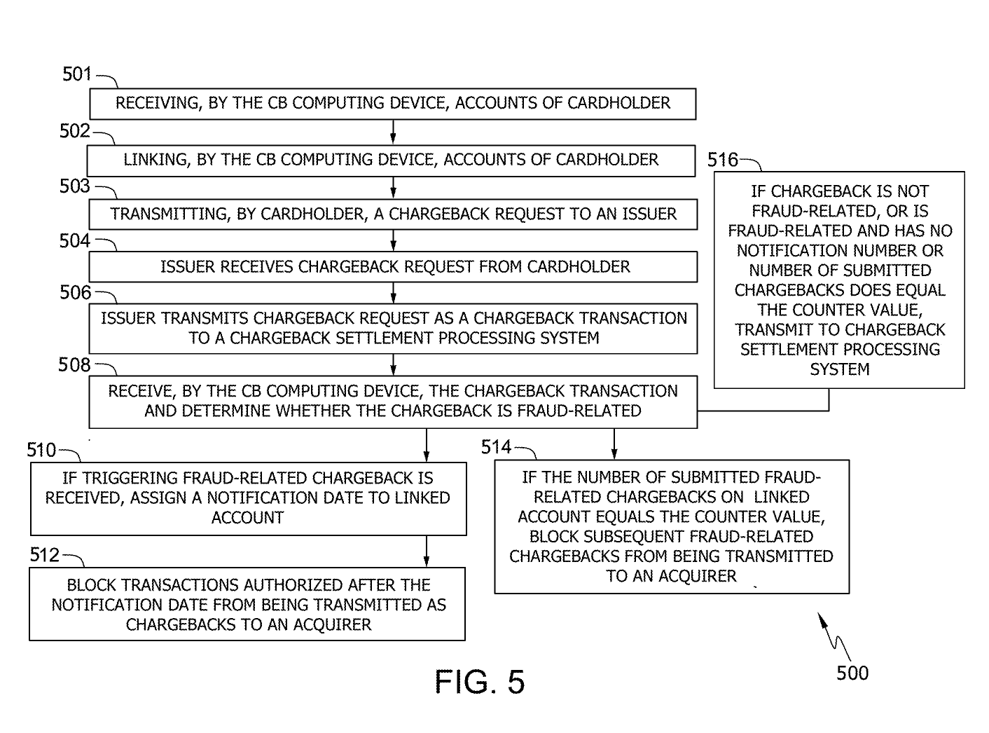

FIG. 5 is a process 500 flow diagram of an example payment card system that includes a CB computing device as shown in FIGS. 1 and 2 for blocking ineligible fraud-related chargebacks associated with a linked account based on a notification date or a counter value. The payment card system used to implement process 500 is system 200 as shown in FIG. 2. In the example embodiment, process 500 includes the CB computing device receiving 501 one or more closed accounts and one or more new accounts associated with a cardholder. The CB computing device links 502 the one or more closed accounts and the one or more new accounts to create a linked account, which is stored within the database. Process 500 further includes transmitting 503 a chargeback request by a cardholder to an issuer. The chargeback request may be transmitted by the cardholder using a cardholder computer system to an issuer computer system.

In the example embodiment, the chargeback request relates to a request for a chargeback of a transaction with a merchant that is charged to an account assigned to the cardholder. The original transaction is initiated using a payment card issued to the cardholder by the issuer and processed by a payment card network. In the example embodiment, the chargeback transaction includes transaction data relating to the original transaction, including an account identifier and a transaction authorization date.

The issuer receives 504 the chargeback request from the cardholder at the issuer computer system. The issuer refunds a transaction amount to the account assigned to the cardholder and determines whether to transmit the transaction for a chargeback to the acquirer.

In the example embodiment, the issuer transmits 506 the chargeback request as a chargeback transaction to a chargeback settlement processing system, for example, the payment processor shown in FIG. 2, or a network (e.g., a payment processing network, an interchange network, or a clearinghouse network). The chargeback settlement processing system facilitates the clearing, settlement, and chargeback processing of transactions between an acquirer and an issuer (or an issuer processor on behalf of the issuer). The chargeback settlement processing system processes batch file and transmits chargeback transaction files to acquirers through acquirer computer systems for settlement.

In the example embodiment, the CB computing device, in communication with the chargeback settlement processing system and/or the payment network, receives 508 the chargeback transaction data and identifies an account identifier, a transaction authorization date, and a reason for the chargeback from the transaction data. The CB computing device performs a lookup with a database and identifies a linked account using the account identifier. If the chargeback is fraud-related, the CB computing device is configured to store the chargeback data in a memory (e.g., database), retrievable by at least the account identifier. Once the CB computing device has received a predefined number of fraud-related chargebacks on the linked account, a triggering fraud-related chargeback triggers 510 the CB computing device to assign a notification date to the linked account. For example, in some embodiments, the second fraud-related chargeback submitted on the linked account is the triggering fraud-related chargeback. The rule for identifying the number of fraud-related chargebacks for triggering the assignment of a notification date is also stored within the database.

For each fraud-related chargeback, the CB computing device is configured to retrieve the linked account to determine whether a notification date is associated with the linked account. If a notification date is associated with the linked account, the CB computing device is configured to compare the transaction authorization date with the fraud notification date. If the transaction authorization date is after the notification date, the CB computing device is configured to block 512 the fraud-related chargeback from being submitted to the chargeback settlement processing system and/or an acquirer.

The CB computing device is further configured to verify whether a total number of submitted fraud-related chargebacks on the linked account equals a predefined counter value. Once the number of submitted fraud-related chargebacks equals 514 the predefined counter value, the CB computing device is also configured to block any subsequent fraud-related chargebacks from being submitted to the chargeback settlement processing system and/or the acquirer. As a result, all submitted fraud-related chargebacks exceeding the predefined counter value are blocked from further processing.

If the reason for the chargeback is not fraud-related or the chargeback is fraud-related but the account identifier is not associated with a fraud notification date or the number of submitted fraud-related chargebacks does not exceed the predefined counter value, the CB computing device transmits 516 the chargeback transaction to the chargeback settlement processing system and/or the acquirer.

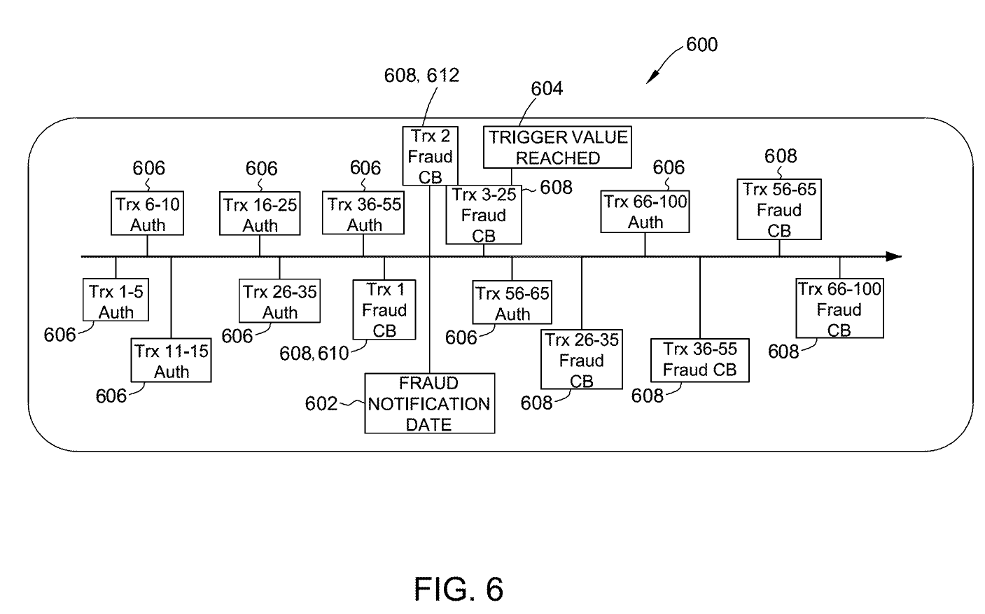

FIG. 6 is a time-line diagram 600 of example transactions being processed by a payment processor and a CB computing device in accordance with one embodiment of the present disclosure. In the example diagram, one hundred payment transactions are authorized 606 by an issuer. The one hundred payment transactions are subsequently submitted 608 by the issuer to a network (e.g., a payment processing network, an interchange network, or a clearinghouse network) for fraud-related chargebacks. In the example embodiment, a counter value is predefined to twenty-five chargebacks, and a notification date is assigned by the CB computing device to a linked account on a second fraud-related chargeback submitted by an issuer (not shown).

The issuer submits a first fraud-related chargeback 610 followed by a second fraud-related chargeback 612. On the second fraud-related chargeback 612, the CB computing device assigns a notification date 602 to the linked account. Prior to notification date 602, the issuer authorizes fifty-five fraudulent payment transactions (i.e., Trx 1-55 Auth). After notification date 602, the issuer authorizes forty-five additional fraudulent payment transactions (i.e., Trx 56-100 Auth).

Using solely notification date 602, the CB computing device is configured to block chargebacks related to transactions 56-100 (i.e., Trx 56-100 Fraud CB) as ineligible for being authorized after notification date 602. Transactions 56-100 may have occurred on one or more accounts. For example, where Account X and Account Y are linked accounts (i.e., a linked account), transactions 56-70 may have occurred on Account X and transactions 71-100 may have occurred on Account Y. Likewise, chargeback 610 and chargeback 612 may have resulted from transactions associated with a same account or different accounts that are linked.

Conversely, the CB computing device does not block chargebacks related to transactions 1-55 that were authorized prior to notification date 602. As a result, transactions 1-55 are transmitted via the network to the acquirer for chargeback processing, while transactions 56-100 are blocked from further transmission.

In addition, using solely counter value 604, transactions 26-100 (i.e., Trx 26-100 Fraud CB) are blocked by the CB computing device as ineligible for exceeding the counter value. The CB computing device does not block transactions 1-25 for fraud-related chargebacks, which are transmitted to the acquirer for chargeback processing. As discussed above, in one embodiment, the CB computing device is configured to apply a single triggering rule, such as notification date 602 or counter value 604, to the submitted chargebacks. In another embodiment, the CB computing device is configured to apply multiple triggering rules, such as both notification date 602 and counter value 604, to the submitted chargebacks.

In the example embodiment, the CB computing device is configured to apply both notification date 602 and counter value 604 to transactions 600, resulting in transactions 26-100 being blocked by the CB computing device for exceeding the counter value. The CB computing device would also apply notification date 602 to block transactions 56-100 as ineligible for being authorized after notification date 602; however, these transactions would also be blocked as ineligible for exceeding the counter value.

Example embodiments of methods and systems for blocking ineligible fraud-related chargebacks are described above in detail. The methods and systems are not limited to the specific embodiments described herein, but rather, components of systems and/or steps of the methods may be utilized independently and separately from other components and/or steps described herein. For example, the methods may also be used in combination with other account systems and methods, and are not limited to practice with only the transaction card account systems and methods as described herein. Rather, the example embodiment can be implemented and utilized in connection with many other data storage and analysis applications.

As will be appreciated based on the foregoing specification, the above-described embodiments of the disclosure may be implemented using computer programming or engineering techniques including computer software, firmware, hardware or any combination or subset thereof, wherein the technical effect is a flexible system for various aspects of fraud analysis of payment card transactions. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for electronically linking accounts within a database and automatically blocking an ineligible fraud-related chargeback from chargeback processing over a network, the method implemented using a chargeback blocking (CB) computing device including a processor and the database, said method comprising:
linking, by the CB computing device, an opened account with at least one closed account, wherein the opened account and the at least one closed account are associated with a cardholder;
storing at least one triggering rule in the database, the at least one triggering rule configured to determine that a fraud-related chargeback is a triggering fraud-related chargeback, wherein the at least one triggering rule includes at least one of a notification date rule and a counter value rule;
receiving, by the CB computing device, a first chargeback submitted for chargeback processing;
determining, by the CB computing device, that the first chargeback is a first fraud-related chargeback associated with one of the linked accounts;
determining, by the CB computing device, that the first fraud-related chargeback is a triggering fraud-related chargeback based at least in part on the at least one stored triggering rule;
receiving, by the CB computing device, a second fraud-related chargeback associated with one of the linked accounts after determining that the first fraud-related chargeback is the triggering fraud-related chargeback;
determining that the second fraud-related chargeback is an ineligible fraud-related chargeback by applying the at least one triggering rule; and
blocking the second fraud-related chargeback from further processing over the network.

2. The method of claim 1, wherein the notification date rule defines a notification date identifying when the triggering fraud-related chargeback was received by the CB computing device for any of the linked accounts, and wherein the ineligible fraud-related chargeback is a payment transaction authorized by an issuer after the notification date.

3. The method of claim 1, wherein the counter value rule defines a counter value identifying a number of allowable fraud-related chargebacks that can be submitted in association with any of the linked accounts, wherein the ineligible fraud-related chargeback is a fraud-related chargeback submitted in excess of the counter value.

4. The method of claim 1 further comprising generating, by the CB computing device, a notification message for transmitting to at least one of an issuer and an acquirer associated with the blocked fraud-related chargeback, the notification message including a reason code identifying a reason for blocking the fraud-related chargeback.

5. The method of claim 1 further comprising blocking any subsequent fraud-related chargebacks received after the second fraud-related chargeback from further processing over the network if the subsequent fraud-related chargebacks are determined to be ineligible based upon the at least one triggering rule.

6. The method of claim 1, wherein storing at least one triggering rule further comprises:
storing a plurality of triggering rules in the database, the plurality of triggering rules including at least one notification date rule and at least one counter value rule, wherein the at least one notification date rule includes setting the notification date for the linked accounts as the date the CB computing device receives the second fraud-related chargeback from an issuer; and
storing, within the database, the date when the second fraud-related chargeback is received by the CB computing device for any of the linked accounts as the notification date.

7. The method of claim 1, wherein the counter value rule defines a counter value of twenty-five fraud-related chargebacks received by the CB computing device for any of the linked accounts.

8. A chargeback blocking (CB) computing device for electronically linking accounts within a database and automatically blocking an ineligible fraud-related chargeback from chargeback processing over a network, the CB computing device comprising:
a processor; and
a database coupled to said processor, said processor configured to:
link an opened account with at least one closed account, wherein the linked accounts are associated with a cardholder;
store at least one triggering rule in the database, the at least one triggering rule configured to determine that a fraud-related chargeback is a triggering fraud-related chargeback, wherein the at least one triggering rule includes at least one of a notification date rule and a counter value rule;
receive, from an issuer, a first chargeback for an account associated with a cardholder, the chargeback including an account identifier;
determine that the first chargeback is a first fraud-related chargeback associated with one of the linked accounts;
determine that the first fraud-related chargeback is a triggering fraud-related chargeback based at least in part on the at least one stored triggering rule;
receive, from the issuer, a second fraud-related chargeback associated with one of the linked accounts after determining the first fraud-related chargeback is the triggering fraud-related chargeback;
determine that the second fraud-related chargeback is an ineligible fraud-related chargeback by applying the at least one triggering rule; and
block the second fraud-related chargeback from further processing over the network.

9. The CB computing device of claim 8, wherein the notification date rule defines a notification date identifying when the triggering fraud-related chargeback was received by the CB computing device, and wherein the ineligible fraud-related chargeback is a payment transaction authorized by the issuer after the notification date.

10. The CB computing device of claim 8, wherein the counter value rule defines a counter value identifying a number of allowable fraud-related chargebacks that can be submitted for any of the linked accounts, and wherein the ineligible fraud-related chargeback is a fraud-related chargeback submitted in excess of the counter value.

11. The CB computing device of claim 8, wherein said processor is further configured to: generate a notification message for transmitting to at least one of the issuer and an acquirer associated with the blocked fraud-related chargeback, the notification message including a reason code identifying a reason for blocking the fraud-related chargeback.

12. The CB computing device of claim 8, wherein said processor is further configured to block any subsequent fraud-related chargebacks received after the second fraud-related chargeback from further processing over the network if the subsequent fraud-related chargebacks are determined to be ineligible based upon the at least one triggering rule.

13. The CB computing device of claim 8, wherein said processor is further configured to set a notification date, per the notification date rule, for the linked accounts as the date when the CB computing device receives the second fraud-related chargeback from the issuer, the notification date being saved within the database as associated with the linked accounts.

14. The CB computing device of claim 8, wherein a counter value is designated by the counter value rule as twenty-five fraud-related chargebacks received by the CB computing device for any of the linked accounts.

15. Computer-readable storage media having computer-executable instructions embodied thereon, wherein when executed by at least one processor associated with a chargeback blocking (CB) computing device, the computer-executable instructions cause the processor to:
link an opened account with at least one closed account, wherein the linked accounts are associated with a cardholder;
store at least one triggering rule in a database, the at least one triggering rule configured to determine that a fraud-related chargeback is a triggering fraud-related chargeback, wherein the at least one triggering rule includes at least one of a notification date rule and a counter value rule;
receive a first chargeback message for an account associated with the cardholder, the chargeback message including an account identifier;
determine that the first chargeback is a first fraud-related chargeback associated with one of the linked accounts;
determine that the first fraud-related chargeback is a triggering fraud-related chargeback based at least in part on the at least one stored triggering rule;
receive a second fraud-related chargeback associated with one of the linked accounts after determining that the first fraud-related chargeback is the triggering fraud-related chargeback;
determine that the second fraud-related chargeback is an ineligible fraud-related chargeback by applying the at least one triggering rule; and
block the second fraud-related chargeback from further processing over the network.

16. The computer-readable storage media in accordance with claim 15, wherein the notification date rule defines a notification date identifying when the triggering fraud-related chargeback was received by the CB computing device for any of the linked accounts, and wherein the ineligible fraud-related chargeback is a payment transaction authorized by an issuer after the notification date.

17. The computer-readable storage media in accordance with claim 15, wherein the counter value rule defines a counter value identifying a number of allowable fraud-related chargebacks that can be submitted in association with any of the linked accounts, wherein the ineligible fraud-related chargeback is a fraud-related chargeback submitted in excess of the counter value.

18. The computer-readable storage media in accordance with claim 15, wherein the computer-executable instructions cause the processor to generate a notification message for transmission to at least one of an issuer and an acquirer associated with the blocked fraud-related chargeback, wherein the notification message includes a reason code identifying a reason for blocking the fraud-related chargeback.

19. The computer-readable storage media in accordance with claim 15, wherein the computer-executable instructions cause the processor to block any subsequent fraud-related chargebacks received after the second fraud-related chargeback from further processing over the network if the subsequent fraud-related chargebacks are determined to be ineligible based upon the at least one triggering rule.

20. The computer-readable storage media in accordance with claim 15, wherein the computer-executable instructions cause the processor to set a notification date using the notification date rule for the linked accounts as the date the CB computing device receives the second fraud-related chargeback from an issuer, the notification date being saved within the database as associated with the linked accounts.

21. The computer-readable storage media in accordance with claim 15, wherein the computer-executable instructions cause the processor to set a counter value using the counter value rule as twenty-five fraud-related chargebacks received by the CB computing device for any of the linked accounts.
